(19) United States
(12) Patent Application Publication
(10) Pub. No.: US 2015/0161517 A1
(43) Pub. Date: Jun. 11, 2015

(54) DEVICE AND METHOD FOR PREDICTING POPULARITY OF SOCIAL DATA

(71) Applicant: ELECTRONICS AND TELECOMMUNICATIONS RESEARCH INSTITUTE, Daejeon (KR)

(72) Inventors: Yong-Jin BAE, Daejeon (KR); Hyun-Ki Kim, Daejeon (KR); Myung-Gil Jang, Daejeon (KR); Mi-Ran Choi, Daejeon (KR); Jeong Heo, Daejeon (KR); Soo-Jong Lim, Daejeon (KR); Hyo-Jung Oh, Daejeon (KR); Chung-Hee Lee, Daejeon (KR); Pum-Mo Ryu, Daejeon (KR); Yeo-Chan Yoon, Daejeon (KR); Yoon-Jae Choi, Daejeon (KR); Yo-Han Jo, Daejeon (KR)

(73) Assignee: ELECTRONICS AND TELECOMMUNICATIONS RESEARCH INSTITUTE, Daejeon (KR)

(21) Appl. No.: 14/243,427

(22) Filed: Apr. 2, 2014

(30) Foreign Application Priority Data
Dec. 10, 2013 (KR) 10-2013-0153281

(51) Int. Cl. G06N 7/00; H04L 29/08

(52) U.S. Cl. CPC G06N 7/005; H04L 67/22

(57) ABSTRACT

A method and device for predicting popularity by setting various criteria of popularity of social data spread over a social network service (SNS) including: a data collecting unit to collect previous data created during a predetermined time and created in real time from data storage associated with an SNS, a data popularity prediction resource building unit to extract user information and data information from the previous data created during the predetermined time and build a social data popularity prediction resource using the extracted user information and data information, and a popularity predicting unit to predict popularity of the social data created in real time using the data information and the user information extracted from the data created in real time and the built popularity prediction resource, in which the predicted popularity includes predicted values of at least two items among a spread amount, a popularity time, and a spread rate.

### CROSS-REFERENCE TO RELATED APPLICATION

This application claims priority to and the benefit of Korean Patent Application No. 10-2013-0153281, filed on Dec. 10, 2013, the disclosure of which is incorporated herein by reference in its entirety.

### BACKGROUND

1. Field of the Invention

The present invention relates to a device and method by which a future issue can be detected based on popularity prediction and a predicted popularity value of social media data (hereinafter referred to as “social data”) created in a social network service (SNS) such as Twitter, Facebook, and Google+ and the result can be provided to a user.

2. Discussion of Related Art

With the spread of social data created in social network services (SNSs) such as Twitter, Facebook, and Google+ and mobile Internet, interest in and importance of such services have been increasing. Among social data created in real time, analysis and prediction of data in which a plurality of users will be interested are main concerns both socially and for companies.

In the related art, there are two methods of predicting popularity of social data. In one method, an influencer is analyzed, and data created by the influencer is considered to be popular data. In the other method, a spread amount of corresponding data is predicted. In the former method, societal influencers are considered to be social network influencers, and it is assumed that data created by the social influencers will be popular with users. However, data created by the same influencer has different spread rates and forms to other users according to various conditions such as a data subject or a data creation time. In addition, since there are various data spread patterns, it is difficult to consider the data created by the influencer to be popular data.

In the latter method, since data spread to a plurality of users may be considered to be popular data, a spread amount of corresponding data is predicted to analyze popularity. The spread amount may be used as a criterion for representing data popularity. However, when the data spreads, since there are various factors to be considered in addition to the spread amount, it has limitations of measuring the data popularity.

### SUMMARY OF THE INVENTION

The present invention provides a method and device for predicting popularity by setting various criteria of popularity of social data spread over a social network service (SNS).

The present invention also provides a method and device for predicting data popularity by calculating the number of spreads, a popularity time, and a spread rate of social data spread over an SNS.

According to an aspect of the invention, there is provided a device for predicting social data popularity. The device may include a social data collecting unit configured to collect previous social data created during a predetermined time and social data created in real time from a data storage associated with a social network service, a social data popularity prediction resource building unit configured to extract user information and data information from the previous social data created during the predetermined time, and build a social data popularity prediction resource using the extracted user information and data information, and a popularity predicting unit configured to predict popularity of the social data created in real time using the data information and user information extracted from the social data created in real time and the built popularity prediction resource, in which the predicted popularity includes predicted values of at least two items among a spread amount, a popularity time, and a spread rate.

According to another aspect of the invention, there is provided a method of predicting social data popularity. The method may include collecting social data spread in real time through a social network service, filtering popularity prediction target social data from the collected social data based on filtering information input by a user, extracting user information and data information of the social data from the filtered social data, and predicting popularity of the social data using the extracted user information and data information and a pre-built social data popularity prediction resource, in which popularity prediction information of the social data includes predicted values of at least two items among a spread amount, a popularity time, and a spread rate.

### BRIEF DESCRIPTION OF THE DRAWINGS

The above and other objects, features and advantages of the present invention will become more apparent to those of ordinary skill in the art by describing in detail exemplary embodiments thereof with reference to the accompanying drawings, in which:

FIG. 1 is a graph analyzing a process of in which social data created in Twitter is spread to other users;

FIG. 2 is a block diagram illustrating a configuration of a device for predicting social data popularity according to an embodiment of the invention;

FIG. 3 is a flowchart illustrating a method of predicting social data popularity according to an embodiment of the invention;

FIG. 4 illustrates an exemplary screen for providing analyzed future issues to a user according to an embodiment of the invention;

FIG. 5 illustrates an exemplary screen for providing information on predicted popularity of data and data content of a corresponding issue when a specific subject word or a keyword is clicked in the exemplary screen of FIG. 4; and

FIG. 6 illustrates an exemplary screen for inputting a search word and a search condition for a future issue to be searched by a user.

### DETAILED DESCRIPTION OF EXEMPLARY EMBODIMENTS

While the invention can be modified in various ways and take on various alternative forms, specific embodiments thereof are shown in the drawings and described in detail below as examples. There is no intent to limit the invention to the particular forms disclosed. On the contrary, the invention is to cover all modifications, equivalents, and alternatives falling within the spirit and scope of the appended claims.

In descriptions of the invention, when it is deemed that detailed descriptions of related well-known technology may unnecessarily obscure the gist of the invention, detailed description thereof will be omitted.

In addition, the singular forms used in the specification and claims are interpreted to include plural forms as well, unless otherwise indicated.

Terms used in the specification such as “module,” “unit,” and “interface,” generally refer to computer related objects, and may refer to, for example, hardware, software, and combinations thereof.

Hereinafter, embodiments of the invention will be described in detail with reference to the accompanying drawings.

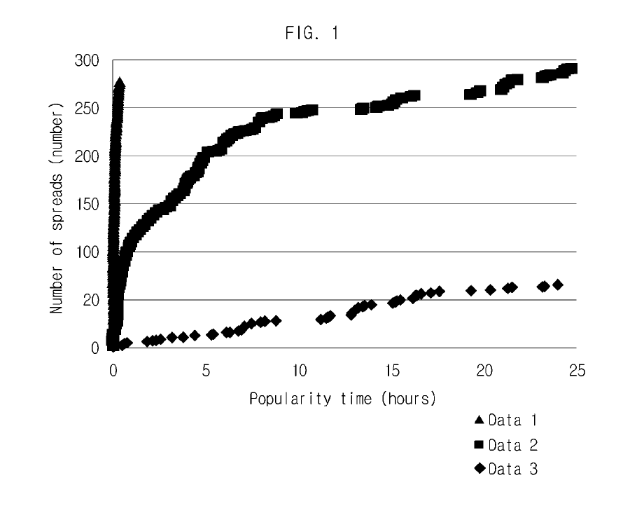

FIG. 1 is a graph analyzing a process in which social data created in Twitter is spread to other users. As illustrated, social data 1, 2, and 3 show various results in terms of the number of spreads and a popularity time.

In this case, when popularity of the social data is determined only in terms of a spread amount, the data 1 and data 2 may be determined as data having similar popularity. However, they show significantly different patterns in terms of the popularity time. The popularity time refers to a time during which users pay attention and a period between a time at which data is created and a time at which the data finally spreads. In addition, when the data 2 and data 3 are compared, popularity times are similar, but spread amounts are significantly different, and spread rates of data are different when a density of data spreads is compared. Therefore, in order to calculate social data popularity, it is necessary to set various criteria for measuring popularity to predict the popularity.

To this end, the invention proposes a method of predicting data popularity using properties (such as a spread amount, a popularity time, and a spread rate) of which information is shared with other users when popularity of social data is predicted. The invention proposes a method of predicting data popularity using information extracting technology for obtaining information used for prediction from previously created data and prediction analysis technology based on extracted information. Specifically, the invention considers the following three items as criteria for measuring data popularity.

1. How widely will a post spread to and receive support from other users?

2. How long will users be interested in a post?

3. How quickly will a post spread to other users?

Item 1 is a criterion of considering a spread amount of data. The spread amount refers to an amount of support or recommendations of created data received from other users, for example, the number of retweets in Twitter and the number of recommendations of a post in Facebook.

Item 2 is a criterion of considering persistence of data. The persistence refers to an item of predicting how long the data will have attention of users after being created. For example, the persistence refers to a period between a time at which a tweet is created and a time at which a final retweet occurs in Twitter, and a period between a time at which a post is created and a time at which a final recommendation is received in Facebook.

Item 3 is a criterion of considering a spread rate of data and refers to an average delivery rate of data between users. For example, the spread rate refers to an average time from a time at which a tweet is created and a retweet occurs to a time at which a subsequent retweet occurs in Twitter, and an average time from a time at which a user creates a post and receives a recommendation to a time at which a subsequent recommendation is received in Facebook.

In the following description, a value measured in consideration of item 1 is referred to as a “spread amount,” a value measured in consideration of item 2 is referred to as a “popularity time,” and a value measured in consideration of item 3 is referred to as a “spread rate.”

In addition, the invention proposes a method of detecting future issues based on predicted data popularity. A popularity value of data predicted according to the invention may be used as the following example. For example, when a lifecycle period of data such as “I wish to have jeans worn by XXX” is predicted as a week, the number of instances of support is predicted as 10000, and the spread rate is predicted as one minute, related companies analyze the demand for the jeans, a period of high sales, and users' interests, and use the results to prepare the jeans in advance.

In this way, by predicting popularity of social data, companies and public institutions may prepare countermeasures and build a model for preparing for occurrence of potentially hazardous issues (such as accidents or non-common events) through early detection before public opinion is formed from a plurality of users.

The term “social data” used herein refers to data created in a social network service (SNS) such as Twitter, Facebook, and Google+ in the following description.

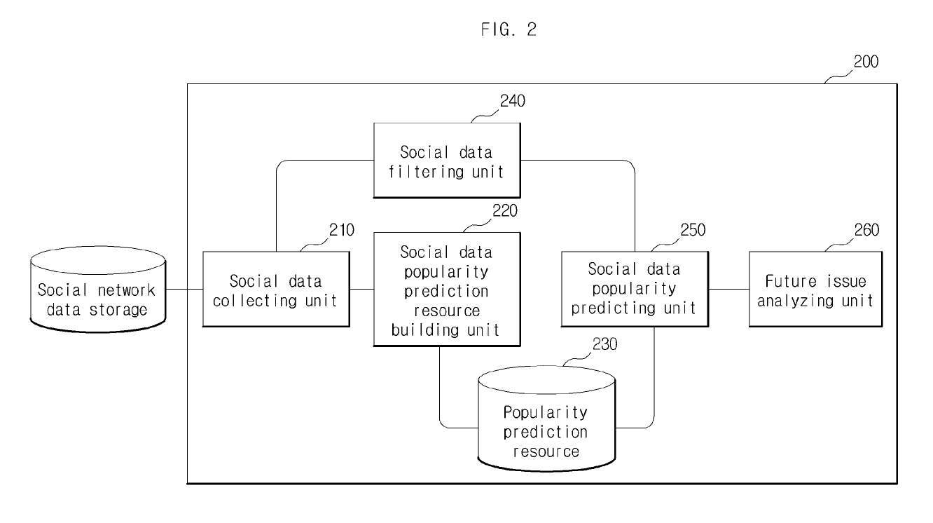

FIG. 2 is a block diagram illustrating a configuration of a device for predicting social data popularity according to an embodiment of the invention. As illustrated, a device for predicting social data popularity 200 may include a social data collecting unit 210, a social data popularity prediction resource building unit 220, a social data filtering unit 240, a social data popularity predicting unit 250, and a prediction result providing unit 260.

In the embodiment, the social data collecting unit 210 may collect social data created in real time and previously created social data from a social network data storage in which social data spread through the social network service is stored. Most social network service (SNS) providers provide a data collecting API which allows users to collect social data. The social data collecting unit 210 uses the data collecting API (not illustrated) provided from the SNS provider and may collect social data from the social network data storage. Although only one exemplary social network data storage is illustrated in FIG. 2, there may be a plurality of data storages provided from various social network service providers (for example, Facebook, and Twitter). The invention is not limited to analysis of social data stored in the data storage provided from a specific service provider.

In the embodiment, the previously created social data collected by the social data collecting unit 210 is provided to the social data popularity prediction resource building unit 220 so as to be used to build a popularity prediction resource for data popularity prediction, and the social data collected in real time may be provided to a popularity predicting unit 250 through a social data filtering unit 240 as a candidate of a popularity prediction target.

The social data popularity prediction resource building unit 220 extracts user (creator) information and social data information from social data collected by the social data collecting unit 210 during a predetermined time, calculates previous popularity (a spread amount, a popularity time, and a spread rate) of corresponding social data using the extracted user information and data information, and thus generates a social data popularity prediction resource.

For example, the data information and user information may include explicit information and/or user defined information.

In the embodiment, the explicit information refers to information on a post or a user provided from a corresponding service. For example, when the prediction target is a tweet, the user information may include at least one of a user ID, the number of followers, the number of friends, the number of posts, a follower ID list, or the like, and the data information may include at least one of text of the tweet, a length of the tweet, the number of retweets, inclusion of a URL, inclusion of a reply, tag information, a tweet ID, a tweet creation time, or the like.

The user defined information refers to information that is newly defined based on information provided from the social network service, and may include user reliability, user activity, a data subject, data informativity, or the like. For example, the user reliability may be measured using a ratio of followees and followers for a Twitter user, and the user activity may be measured using a ratio of the number of tweets posted from a day of creating a Twitter account up to the present. The data subject refers to a criterion for classifying subjects based on data content and may be classified as, for example, travel, science, sports, arts, life, health, job, education, or the like. The data informativity may be determined using a text length and inclusion of URL information.

In this way, the user information and data information of the previously created social data are used to calculate previous popularity (a spread amount, a popularity time, and a spread rate) of corresponding social data, and thus it is possible to generate the social data popularity prediction resource.

The prediction resource may be built in two forms according to a popularity prediction method. In the first prediction method, previous social data having information (user information/data information) similar to prediction target data is used to predict popularity. When the social data popularity is predicted using this method, the prediction resource may include a DB in which various pieces of data information and user information are extracted from the previously created social data and stored. That is, the prediction resource stored in a popularity prediction resource DB 230 may include the data information and user information of each piece of social data previously created over a predetermined time. Such a prediction resource may be used when a prediction method such as K nearest neighbors (KNN) is applied to a process of popularity prediction that is performed by the social data popularity predicting unit 250.

In the second method, when a specific user creates a post, a probability model for predicting popularity of the post is created and is stored in the popularity prediction resource DB 230. It is possible to create the probability model by calculating a popularity probability (a spread amount, a popularity time, and a spread rate) of each post or tweet. In the embodiment, as a method of calculating the probability, machine learning algorithms such as support vector machines, logistic regression, and decision trees may be used.

For example, the prediction resource built (created) by the popularity prediction resource unit 220 may be additionally extended as necessary. The popularity prediction resource created in this way may be stored in the popularity prediction resource DB 230.

The social data filtering unit 240 filters popularity prediction target social data from social data collected in real time by the social data collecting unit 210. For example, the user of the device 200 may exclude data unwanted as the popularity prediction target according to a specific creator of social data or specific data content, or may input filtering information such as a specific creator ID or a specific keyword to be used in filtering when the user wants to predict only specific data. The social data filtering unit 240 may filter popularity prediction target social data based on the filtering information input by the user. In addition, by inputting sex, age, or the like of the user as a condition, it is possible to filter popularity prediction target social data.

The social data popularity predicting unit 250 extracts the data information and user information of the popularity prediction target social data filtered by the social data filtering unit 240 and predicts popularity of corresponding social data using the extracted data information and user information and the popularity prediction resource DB 230.

In the embodiment, predicted popularity may include predicted values of at least two pieces of information among a spread amount, a popularity time, and a spread rate of the popularity prediction target social data.

In the embodiment, when data information and user information of the previously created social data are stored in the popularity prediction resource DB 230, N pieces of data having the most similar information to the prediction target data are extracted from the prediction resource DB 230, an average value of popularity of the extracted N pieces of data is calculated, and thus it is possible to predict the popularity. Here, the popularity may include at least two items of a spread amount, a popularity time, and a spread rate.

In another embodiment, when a calculated popularity (probability) of each piece of previously created social data is stored in the prediction resource DB 230, it is possible to predict the popularity by setting a popularity threshold of the prediction target social data. For example, when a spread amount of data created by a user A is predicted, a probability of support (a recommendation or a retweet) of users other than the user A may be derived and it is possible to predict the spread amount by calculating the number of users having a specific threshold or more.

The future issue analyzing unit 260 may analyze time series based future issues using popularity of popularity prediction target social data created by the social data popularity predicting unit 250. For example, the future issue analyzing unit 260 analyzes text of social data in which at least two pieces of information among a predicted spread amount, a popularity time, and a spread rate are greater than a selected threshold and thus it is possible to extract the future issue. Text analysis of social data may be performed using various methods such as text subject or keyword extracting technology, web trend analyzing technology, event extracting technology, and document summary technology, and is not limited to a specific method.

In addition, when the user inputs a search condition and a search word related to a future issue in which he or she is interested, the future issue analyzing unit 260 may provide a search result of the future issue according to the input search word and search condition.

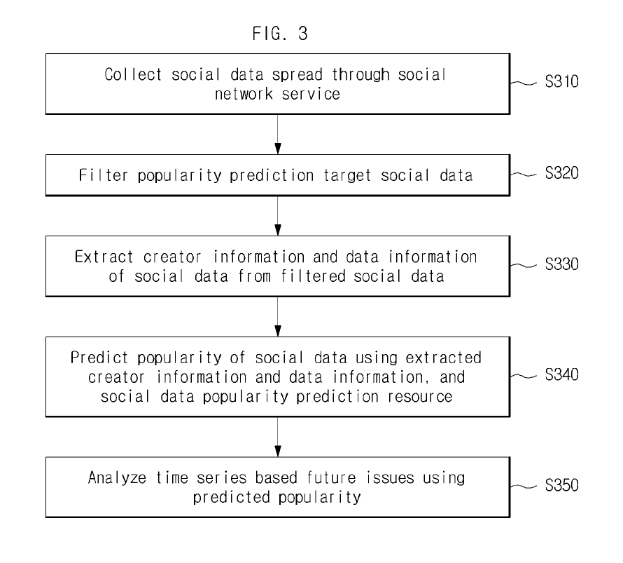

FIG. 3 is a flowchart illustrating a method of predicting social data popularity according to an embodiment of the invention.

In S310, social data spread over the SNS is collected in real time. For example, it is possible to collect social data from the social network data storage using a data collecting API provided by an SNS provider.

In S320, popularity prediction target social data is filtered from social data collected in real time. For example, it is possible to filter popularity prediction target social data based on filtering information input by the user.

In S330, user information and data information of the social data are extracted from the filtered popularity prediction target social data.

For example, when the social network service is Twitter, the user information extracted from the social data includes at least one of an ID of the creator, the number of followers of the creator, the number of friends, the number of posts, and a follower ID list. The data information extracted from the social data may include at least one of text of a tweet, a tweet length, the number of retweets, inclusion of a reply, tag information, a tweet ID, and a tweet creation time. In addition, user defined user information may include user reliability, user activity, or the like. The data information may include a post subject, post informativity, or the like.

In S340, the data information and user information of the social data extracted in the previous step and a pre-built social data popularity prediction resource are used to predict popularity of the social data. In the embodiment, predicted popularity may include predicted values of at least two pieces of information among a spread amount, a popularity time, and a spread rate.

In the embodiment, when data information and user information of previously created social data are stored in the pre-built social data popularity prediction resource DB, N pieces of data having the most similar information to the prediction target data are extracted from the prediction resource DB, an average value of popularity of the extracted N pieces of data is calculated, and thus it is possible to predict the popularity.

In another embodiment, when a calculated popularity (probability) of the previously created social data is stored in the popularity prediction resource DB, it is possible to predict the popularity by setting a popularity threshold of the prediction target social data. For example, when a spread amount of data created by a user A is predicted, a probability of support (a recommendation or a retweet) of users other than the user A may be derived and it is possible to predict the spread amount by calculating the number of users having a specific threshold or more.

In S350, the predicted popularity is used to analyze time series based future issues. In the embodiment, it is possible to extract the future issue by analyzing text of social data in which predicted values of at least two pieces of information among a spread amount, a popularity time, and a spread rate are greater than a selected threshold.

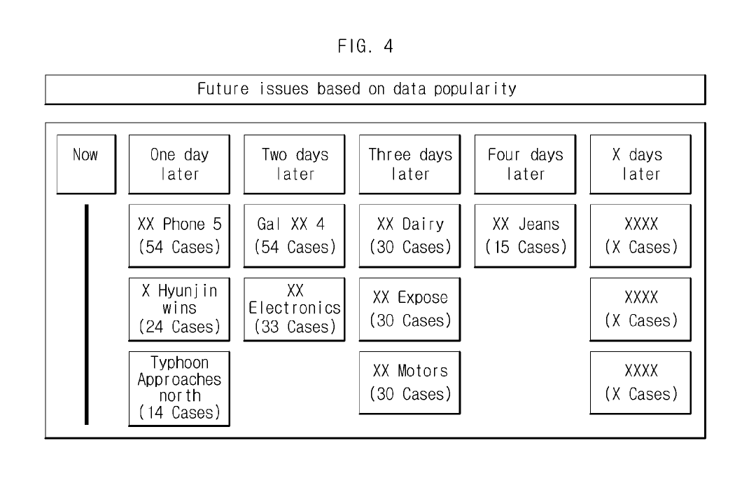

FIG. 4 illustrates an exemplary screen for providing analyzed future issues to a user according to an embodiment of the invention. As illustrated, it is possible to check how many days users will be interested in a subject word or a keyword of predicted data with respect to a current time, and it is possible to check the amount of data in which similar content is created. It is possible to check the amount of predicted support for a corresponding issue through an explicit value or colors of a subject or a keyword. For example, when the issue is expected to receive a large amount of support, a dark color is used to express that the issue needs more attention.

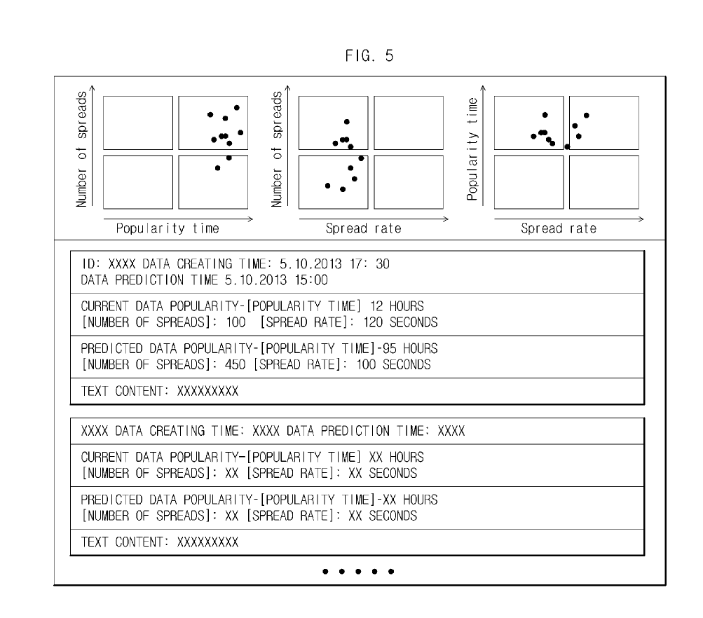

FIG. 5 illustrates an exemplary screen for providing information on predicted popularity of data and data content of a corresponding issue when a specific subject word or a keyword is clicked in the exemplary screen of FIG. 4. Predicted popularity values of posts corresponding to keywords are schematically illustrated based on the criteria and thus it is possible to check characteristics of the corresponding issue.

As illustrated, graphs indicating a correlation between popularity prediction information items are shown at the top of a screen. The user may estimate influences of social data using the illustrated graphs. For example, it is possible to estimate influences of social data using a relation graph between the spread amount and the popularity time as follows.

1. Data predicted to have a short popularity time and a small spread amount: some users are interested in the data but the interest will soon disappear, and the data will have little influence.

2. Data predicted to have a long popularity time and a small spread amount: although the data will receive constant interest, the data will influence only some users.

3. Data predicted to have a short popularity time and a large spread amount: the data will be quickly shared among a plurality of users and thus it is necessary to cope with the data quickly.

4. Data predicted to have a long popularity time and a large spread amount: the data will receive interest from a plurality of users for a long time, and will have great influence, and thus requires much attention and management.

Additionally, at the bottom of the screen, in addition to text content of social data, information of a spread amount, a popularity time, and a spread rate which are currently in progress and information of a predicted spread amount, a predicted popularity time, and a predicted spread rate are displayed together. Therefore, it is possible for the user to compare current popularity and predicted future popularity.

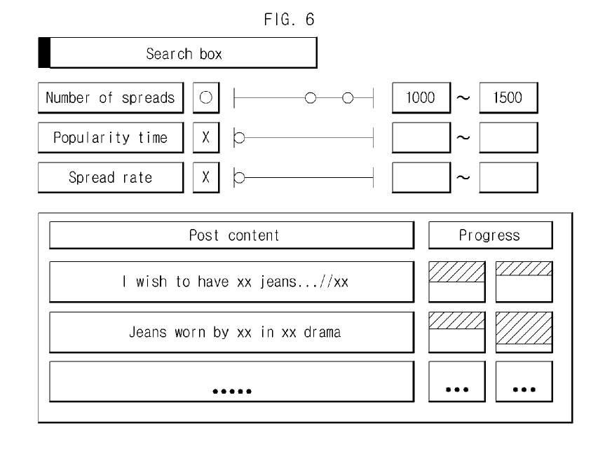

FIG. 6 illustrates an exemplary screen for inputting a search word and a search condition for a future issue to be searched by the user. The user may input a search word to be searched in a search box. In addition, in order to restrict a search target, the user may select and use conditions of a spread amount, a popularity time, and a spread rate depending on popularity characteristics of data. Some or all conditions may be selected and used or a restriction function may not be used. The value of data popularity may be set by a progressive bar or direct input. A search result summarizes and shows data content, predicted popularity of data, and currently received popularity. Detailed information of corresponding data may be checked using a click or a mouse cursor.

The device and method according to the embodiment of the invention may be implemented in the form of a computer instruction that can be performed through various computer components and may be recorded in computer readable recording media. The computer readable recording media may include a program instruction, a data file, and a data structure, and/or combinations thereof.

The program instruction recorded in the computer readable recording media may be specially designed and prepared for the invention or may be an available well-known instruction for those skilled in the field of computer software. Examples of the computer readable recording media include, for example, magnetic media such as a hard disk, a floppy disk, and a magnetic tape, optical media such as a CD-ROM and a DVD, magneto-optical media such as a floptical disk, and a hardware device, such as a ROM, a RAM, and a flash memory, that is specially made to store and perform the program instruction. The media may include transmission media such as a waveguide, a metal strip, or lights including a carrier wave for transmitting a signal designating the program instruction, the data structure, or the like. Examples of the program instruction may include a machine code generated by a compiler and a high-level language code that can be executed in a computer using an interpreter.

Such a hardware device may be configured as at least one software module in order to perform operations of the invention and vice versa.

According to the embodiment of the invention, it is possible to obtain the following effects.

Social Data Popularity Prediction

In the related art, popularity of social data is measured based on popularity of a creator. However, the present invention predicts data popularity even in consideration of data content rather than only depending on the creator. This is important in predicting social data. This is because, even when data is created by a famous person, the data may include meaningless content that will not receive interest from other users.

Since indexes of data influence (a spread amount, a popularity time, and a spread rate) are numerically predicted, it is possible to flexibly cope with characteristics of data popularity and data content.

Future Issue Prediction/Analysis

In web trend analyzing technology in the related art, data from past to present is analyzed, corporate/social/cultural/political issues are detected, and issues that may arise in the future are prepared for based on the result. However, since the technology is based on data up to now, it is difficult to predict future issues and predict a length and an extent of the influence of current issues. However, according to the invention, it is possible to predict influences on the future and future issues based on data popularity.

Future Issue Summary and Search

It is possible to monitor how long an issue will persist based on a current time and check and cope with influences of a corresponding issue on users. In addition, it is possible to search a desired issue according to data popularity and analyze power of influence of issues.

While the present invention has been particularly described with reference to exemplary embodiments, it will be understood by those skilled in the art that various changes in form and details may be made without departing from the spirit and scope of the present invention. Therefore, the exemplary embodiments should be considered in a descriptive sense only and not for purposes of limitation. The scope of the invention is defined not by the detailed description of the invention but by the appended claims, and encompasses all modifications and equivalents that fall within the scope of the appended claims and will be construed as being included in the present invention.

What is claimed is:

1. A device for predicting social data popularity, comprising:
a social data collecting unit configured to collect previous social data created during a predetermined time and social data created in real time from a data storage associated with a social network service;
a social data popularity prediction resource building unit configured to extract user information and data information from the previous social data and build a social data popularity prediction resource using the extracted user information and data information; and
a popularity predicting unit configured to predict popularity of the social data created in real time using data information and user information extracted from the social data created in real time and the popularity prediction resource,
wherein the predicted popularity includes predicted values of at least two items among a spread amount, a popularity time, and a spread rate.

2. The device of claim 1, wherein, when the social network service is Twitter, the user information includes at least one of an ID of the creator, the number of followers of the user, the number of friends, the number of posts, and a follower ID list.

3. The device of claim 1, wherein, when the social network service is Twitter, the data information includes at least one of text of a tweet, a tweet length, the number of retweets, inclusion of a reply, tag information, a tweet ID, and a tweet creation time.

4. The device of claim 1, further comprising:
a social data filtering unit configured to filter popularity prediction target social data from the social data created in real time,
wherein the social data popularity predicting unit predicts popularity of the filtered prediction target social data.

5. The device of claim 1, wherein, when the social network service is Twitter, the collected social data refers to a tweet, the spread amount refers to the number of retweets of the tweet, the popularity time refers to a period between a time at which the tweet is created and a time at which a final retweet occurs, and the spread rate refers to an average time interval of retweets.

6. The device of claim 1, wherein, when the social network service is Facebook, the collected social data refers to a post, the spread amount refers to the number of recommendations of the post, the popularity time refers to a period between a time at which the post is created and a time at which a final recommendation is received, and the spread rate refers to an average time interval of recommendations of the post.

7. The device of claim 1, further comprising
a future issue analyzing unit configured to analyze text of social data in which predicted values of at least two items among the spread amount, the popularity time, and the spread rate are greater than a selected threshold and extract a future issue.

8. A method of predicting social data popularity, comprising:
collecting social data spread in real time through a social network service;
filtering popularity prediction target social data from the collected social data based on filtering information input by a user;
extracting user information and data information of the social data from the filtered social data; and
predicting popularity of the social data using the extracted user information and data information and a pre-built social data popularity prediction resource;
wherein popularity prediction information of the social data includes predicted values of at least two items among a spread amount, a popularity time, and a spread rate.

9. The method of claim 8, wherein the pre-built social data popularity prediction resource includes user information and data information of social data previously created during a predetermined time.

10. The method of claim 8, wherein, when the social network service is Twitter, the collected social data refers to a tweet, the spread amount refers to the number of retweets of the tweet, the popularity time refers to a period between a time at which the tweet is created and a time at which a final retweet occurs, and the spread rate refers to an average time interval of retweets.

11. The method of claim 8, wherein, when the social network service is Facebook, the collected social data refers to a post, the spread amount refers to the number of recommendations of the post, the popularity time refers to a period between a time at which the post is created and a time at which a final recommendation is received, and the spread rate refers to an average time interval of recommendations of the post.

12. The method of claim 8, further comprising
analyzing text of social data in which predicted values of at least two items among the spread amount, the popularity time, and the spread rate are greater than a selected threshold and extracting a future issue.
